(19) United States
(12) Patent Application Publication
(10) Pub. No.: US 2006/0159414 A1
(43) Pub. Date: Jul. 20, 2006

(54) Systems and methods for associating graphics information with audio and video material

(75) Inventors: Bruno Wolf, Boalsburg, PA (US); Kevin Prince, Wilton, CT (US); Vijay Sundaram, San Jose, CA (US); Lou Garvin, Feeding Hills, MA (US)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: Pinnacle Systems, Inc.

(21) Appl. No.: 11/034,964

(22) Filed: Jan. 14, 2005

(51) Int. Cl. H04N 5/93

(52) U.S. Cl. 386/52

(57) ABSTRACT

Methods and systems are provided for associating and editing audiovisual material and graphics information. Audiovisual material is captured from at least one source, and graphics information is generated by a graphics generator. A graphics integration module allows insertion and editing of the graphics information when the audiovisual material is edited. The edited audiovisual material and edited graphics information is output for broadcast such that the edited graphics information appears at the correct time relative to when the edited audiovisual material is output.

### TECHNICAL FIELD

The present invention generally relates to data processing. More particularly, the invention relates to systems, methods and computer-readable media for integrating graphics information with audio and video material during editing of the audio and video material and presenting the graphics information for broadcast.

### BACKGROUND

Audio and video (A/V) processing systems are widely used, by both private users and professionals. In particular, A/V processing systems that allow users to capture, manipulate and playback A/V material are popular in both the consumer and professional market segments. These A/V processing systems are especially important to the entertainment and media industries. For example, news and other media agencies may utilize such systems to produce and broadcast information to viewers across the world.

Given the near instantaneous flow of information in society today, A/V editing and playback systems must allow users to efficiently and effectively capture, manipulate and present various types of information from various sources. Conventional A/V editing and playback systems, however, are deficient in many aspects. For example, conventional systems may not allow users to simultaneously and frame-accurately edit A/V information from various sources and graphics information (e.g., text, images, clips, logos, etc.) for broadcast in an efficient and effective fashion. Further, conventional systems may not allow users to effectively re-edit information and re-load previously edited information for additional manipulation.

### SUMMARY

Consistent with the present invention, methods, systems and computer-readable media are disclosed for associating graphics information with audio and video material during editing of the audio and video material and frame accurately outputting the edited information and material for broadcast.

Consistent with the present invention, a method may be provided for processing audiovisual material and graphics information. The method may comprise: capturing audiovisual material from at least one source; generating graphics information; editing the graphics information while editing the audiovisual material; and outputting the edited audiovisual material and edited graphics information for broadcast such that the edited graphics information appears at a correct time relative to when the audiovisual material is output.

Consistent with the present invention, a system for editing audiovisual material may be provided. The system may comprise: a capture system that captures audiovisual material from at least one source; an editing system that enables editing of the audiovisual material; a playback system for outputting edited audiovisual material for broadcast; and a graphics integration module embedded within the editing system and the playback system that associates graphics information with edited audiovisual material while the audiovisual material is being edited such that the graphics information appears with the edited audiovisual material at a correct time relative to when the edited audiovisual material is output by the playback system.

Consistent with the present invention, a graphics integration module may be provided. The graphics integration module may comprise: a first application embedded within an editing system, wherein the editing system allows editing of audiovisual content. The first application may include: a browser that allows graphics information to be selected and added to the audiovisual content while the audiovisual content is edited; and an editor that allows graphics information added to the audiovisual content to be edited. The graphics integration module may comprise a second application embedded within a playback system, wherein the playback system outputs edited audiovisual content and edited graphics information for broadcast, the second application controlling the playback system to output edited graphics information such that the edited graphics information appears with the edited audiovisual content at a correct time relative to when the audiovisual content is output by the playback system in accordance with the edited audiovisual content.

In certain embodiments, the first application may include functionality for automatically adding caption information received from the editing system to the audiovisual content. The editing system may create text files in which each line of the text files is associated with a particular segment of the audiovisual content. The first application may load the text files and produce graphics templates that include text from the text files for display via the browser.

The foregoing background and summary are not intended to be comprehensive, but instead serve to help artisans of ordinary skill understand the following implementations consistent with the invention set forth in the appended claims. In addition, the foregoing background and summary are not intended to provide any independent limitations on the claimed invention.

### BRIEF DESCRIPTION OF THE DRAWINGS

The accompanying drawings show features of implementations consistent with the present invention and, together with the corresponding written description, help explain principles associated with the invention. In the drawings:

FIG. 1 illustrates an exemplary A/V processing environment consistent with the present invention;

FIG. 2 is a block diagram of an exemplary implementation of a graphics integration module consistent with the present invention;

FIG. 3 illustrates an exemplary screen shot consistent with the present invention;

FIGS. 4A-4B illustrate additional exemplary screen shots consistent with the present invention;

FIG. 5 is a block diagram of an exemplary data processing system consistent with the present invention;

FIG. 6 is a flowchart depicting an exemplary workflow consistent with the present invention;

FIG. 7 is a flowchart depicting an exemplary method for adding graphics consistent with the present invention; and

FIG. 8 is a flowchart depicting an exemplary editing method consistent with the present invention.

### DETAILED DESCRIPTION

The following description refers to the accompanying drawings, in which, in the absence of a contrary representation, the same numbers in different drawings represent similar elements. The implementations set forth in the following description do not represent all implementations consistent with the claimed invention. Instead, they are merely some examples of systems and methods consistent with the invention. Other implementations may be used and structural and procedural changes may be made without departing from the scope of present invention.

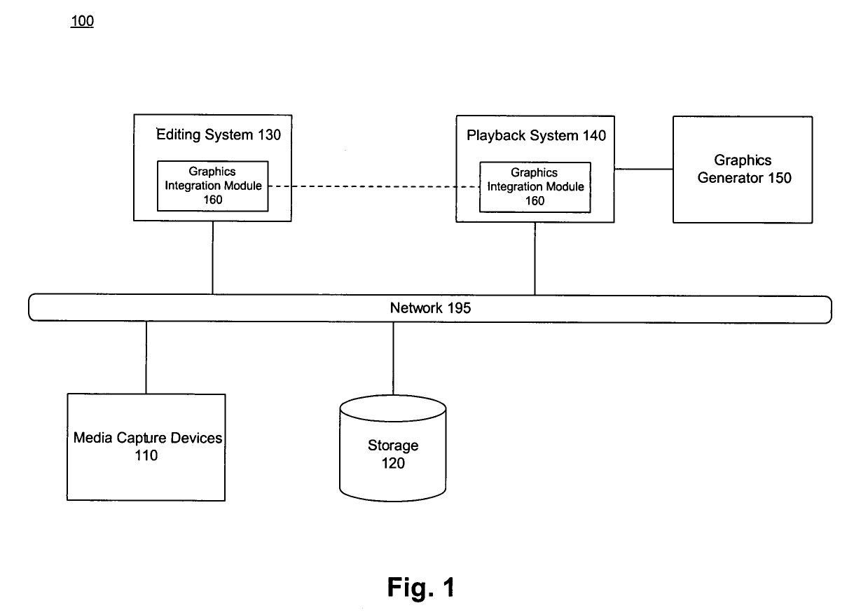

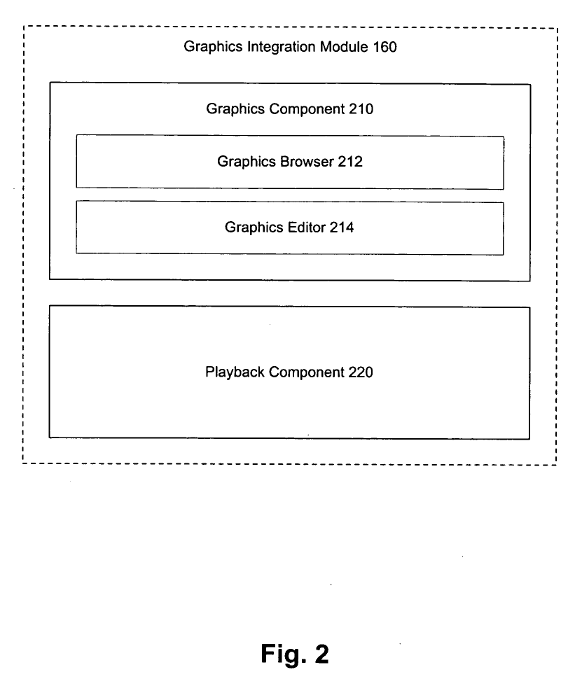

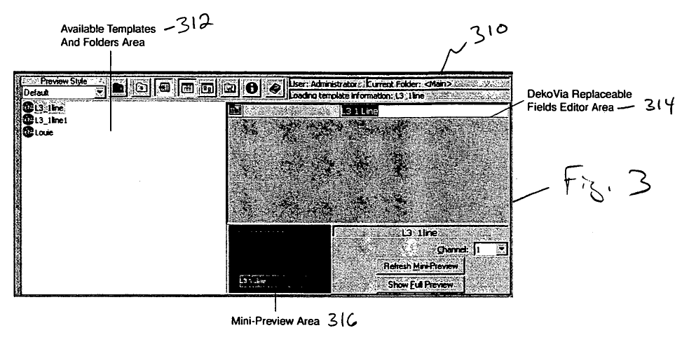

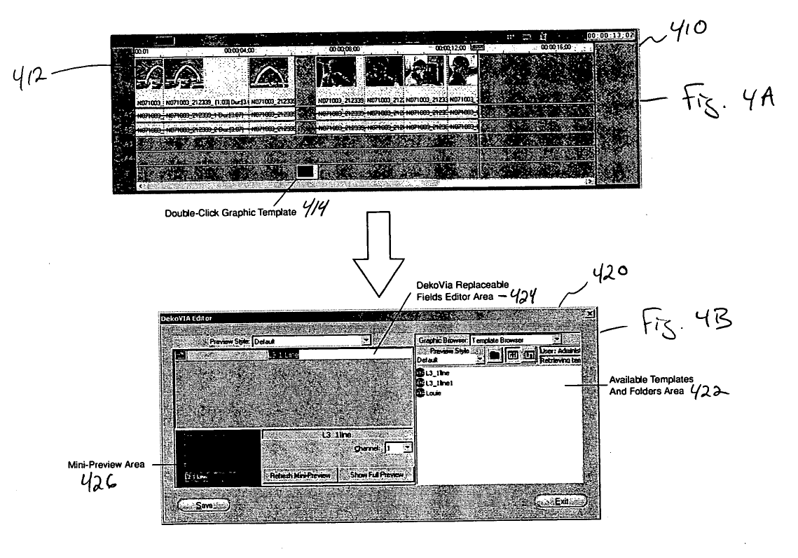

FIG. 1 illustrates an exemplary A/V processing environment 100 consistent with the present invention. The illustrated components are exemplary only, and environment 100 may comprise additional and/or fewer components. As illustrated in FIG. 1, environment 100 may include one or more media capture devices 110, storage 120, an editing system 130, a playback system 140, a graphics generator 150, and a graphics integration module 160. One or more of these components may be interconnected via a network 195.

Media capture devices 110 may include hardware, software, and/or firmware components that facilitate the capture of audio and/or video information. In one configuration, media capture devices 110 may include one or more input channels, encoders, and loading systems. Media capture device 110 may obtain information in various formats, such as analog, SDI, SDTI, DV, HD, IMX, ASI, etc. One or more encoders may be included for encoding received information in various formats, such as DV25 and/or MPEG. Media capture devices 110 may be configured to obtain audio and video content from various sources, such as tape, satellite feeds, processes, etc. Media capture devices 110 may also initiate information capture from third parties. In one example, media capture devices 110 may obtain A/V data associated with a news reporter or another event intended for a television broadcast.

Storage 120 may represent any resource that stores, manages, and provides access to information. Storage 120 may store A/V information captured from media capture device 110. It may also store graphics information, playlists, and other data, as discussed below. Storage 120 may be implemented with a variety of components or subsystems including, for example, magnetic and optical storage elements, organic storage elements, audio disks, and video disks. In one implementation, storage 120 may include one or more elements of a storage area network (SAN). Storage 120 may include one or more structured data archives distributed among one or more network-based data processing systems. Storage 120 may include one or more relational databases, distributed databases, object-oriented programming databases, and/ or any other mechanism, device, or structure for managing, accessing, and updating an aggregation of data.

In certain implementations, storage 120 may include and/or leverage one or more file systems and controllers, e.g., a Windows XP server, (not illustrated in FIG. 1) for managing information stored in storage 120. Devices in environment 100 may operatively connect to storage 120 via one or more communication protocols and devices. In one example, devices may connect to storage 120 by way of optical fiber, Fibre Channel, SCSI (Small Computer System Interface), and/or iSCSI (Internet SCSI) technology. For example, devices could be connected to storage 120 using ESCON (Enterprise Systems Connection) technology, Fibre Channel over IP (FCIP), and/or the Internet Fibre Channel Protocol (iFCP).

Editing system 130 may include hardware, software, and/or firmware components that edit audio and video material, as well as graphics information (e.g., graphics information generated by graphics generator 150 or other sources), stored in storage 120. In one embodiment, editing system 130 may be implemented within a computer workstation. Editing system 130 may provide one or more user interfaces that enable users to access audio and video material and perform editing operations on the material. Editing system 130 may also provide one or more user interfaces that enable access to and editing of graphics information. In one implementation, editing system 130 may present timelines associated with audio and video information, which may include graphics information. Editing system 130 may perform various editing operations, such as trimming of clips, effects editing, audio editing, voice over editing, timeline editing, etc. Further, editing system 130 may allow for edits of both hi- and low-resolution formats and may allow graphic elements to be combined with either format. Editing system 130 may also provide various searching and browsing features. In addition, editing system 130 may create playlists that may be used by playback system 140. As used herein the term “playlist” refers to a sequence of cuts. A “cut” may include any continuous segment of video, audio and/or graphic information. A cut may include, for example, a segment of information out of a video, audio, or graphics file.

Playback system 140 may include hardware, software, and/or firmware components that output or play out audio and video material for broadcast. In one implementation, playback system 140 may include a server configured to output data for a television broadcast. Playback system 140 may obtain playlists from storage and output the corresponding data to one or more broadcast devices.

Playback system 140 may play out unedited or edited audio and video material stored in storage 120. When playing out unedited information, playlists may not be used. When playing out edited information, however, one or more playlists generated by editing system 130, and possibly stored on storage 120, may be used by playback system 140 in order to determine what information to play out and the order in which the information should be played out.

Graphics generator 150 may include hardware, software, and/or firmware for generating, accessing, managing and/or playing out for broadcast graphics information, such as (two- or three-dimensional) characters, images, text, clips, logos, etc. Graphics generator 150 may provide various mixing, routing, and keying functions. In one embodiment, graphics generator may facilitate various combinations of video with real-time playback of clips, graphics, and effects. For example, graphics generator 150 may facilitate credit sequences.

Although illustrated as external to playback system 140, all or part of graphics generator 150 could be implemented within or as part of playback system 140. In such an implementation, all of part of graphics generator 150 could be located or embedded in playback system 140. In addition, certain functions of graphics generator 150 could be integrated into, or performed by, components of playback system 140.

In one embodiment, graphics generator 150 may generate graphics information in the form of templates, which can be defined by users or programmed. Each template may contain static layers as well as replaceable layers of data. The static layers may be permanent, while the replaceable layers may include content specified and changeable by users. The replaceable layers may contain text, stills, shapes, background colors, photos, clips, etc. Graphics generator 150 may store templates in a pre-determined location in storage 120 for access by other components in environment 100.

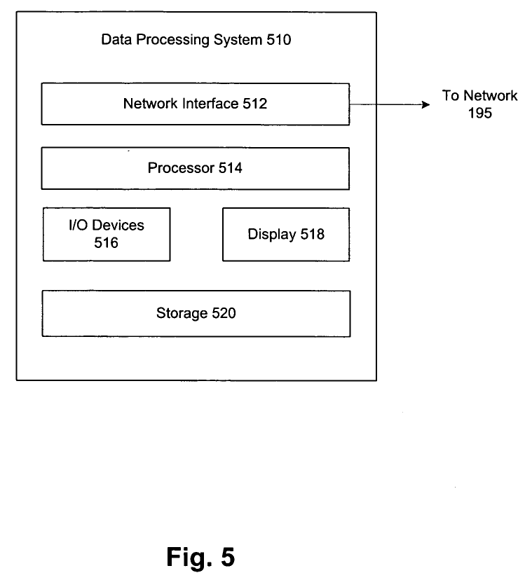

In addition to creating graphic templates, graphics generator 150 may play the templates out by converting them to broadcast quality video. Further, graphics generator 150 may play out graphics information (e.g., templates) created by other sources. For example, one or more applications running on one or more data processing systems (not shown), e.g., a desktop, a laptop, a workstation, etc., coupled to network 195 may allow users to create graphics templates. The applications may create templates in the same format that graphics generator 150 creates templates. In certain implementations, the applications may run on one or more data processing systems similar in structure to the data processing system described below in connection with FIG. 5. Graphics generator 150, although capable of also creating graphics templates, may play out for broadcast template graphics generated by these other sources. Graphics generator 150 could even be configured to play out template graphics generated by other sources and not create templates itself.

Graphics integration module 160 may associate graphics information generated and/or accessed by graphics generator 150 with stored A/V information. For example, graphics integration module 160 may allow users to insert credits, logos, etc. over video content. Graphics integration module 160 may also facilitate editing of graphics information. In one embodiment, graphics integration module 160 may associate graphics information with stored A/V information when that A/V information is being edited (e.g., via editing system 130). For example, graphics integration module 160 may allow a user to select graphics information from a listing and insert the selected graphics into A/V material as that material is being edited. Graphics integration module 160 may also facilitate simultaneous editing of graphics information and A/V material. That is, graphics integration module 160 may allow users to edit graphics information while editing A/V material via editing system 130.

Graphics integration module 160 may also interact with playback system 140 to facilitate frame-accurate playback of graphics information. That is, graphics integration module 160 may obtain information from playback system 140 in order to control graphics generator 150 so that it plays out (for broadcast) the graphics information at a correct time relative to when the edited audiovisual material is output by the playback system.

Graphics integration module 160 may be implemented using a variety of hardware, software, and/or firmware components. Graphics integration module 160 may include one or more components that are dispersed or embedded within environment 100. For example, as illustrated in FIG. 1, graphics integration module 160 may include components embedded in editing system 130 and components embedded in playback system 140. Additional details of graphics integration module 160 are discussed below in connection with FIG. 2

Network 195 in FIG. 1 may be any appropriate structure for enabling communication between two or more nodes or locations. Network 195 may include a shared, public, or private data network and encompass a wide area or local area. Network 195 may also include a broadband digital network. Network 195 may employ communication protocols such as User Datagram Protocol (UDP), Transmission Control and Internet Protocol (TCP/IP), Asynchronous Transfer Mode (ATM), SONET, Ethernet, or any other compilation of procedures for controlling communications among network locations. Further, in certain embodiments, network 195 may leverage voice-over Internet Protocol (“VoIP”) technology. Moreover, network 195 may include optical fiber, Fibre Channel, SCSI, and/or iSCSI technology and devices.

Although modules 110, 120, 130, 140, 150 and 160 are depicted as discrete elements, the functionality of those modules may overlap and exist in a fewer (or greater) number of modules. For example, all components of environment 100 may be incorporated into a single computer system, in which case network 195 may be implemented as a computer bus. Further, in certain implementations, environment 100 may not include one or more of the illustrated modules. Moreover, environment 100 may include additional components/modules and functionality not illustrated in FIG. 1.

FIG. 2 illustrates an exemplary implementation of graphics integration module 160 consistent with the present invention. As illustrated, graphics integration module 160 may include a graphics component 210 and a playback component 220. In one configuration, graphics component 210 may be embedded in editing system 130 and playback component 220 may be embedded in playback system 140.

Graphics component 210 may allow users, when performing editing via editing system 130, to associate graphics information, which may be generated by graphics generator 150 or other source(s), with audio and video material received by capture devices 110. Graphics component 210 may access the graphics information and audio/video material from storage 120, and may allow users to insert or drop selected graphics templates into a timeline generated by editing system 130. Graphics component 210 may also allow users to complete template data during editing. For example, users can specify the particular data used for the replaceable layers (e.g., text, clips, stills, etc.) of a template when inserting the template into a timeline during an editing operation. In addition to enabling users to fulfill template data during editing, graphics component 210 may allow users to specify in a template that all or some of the replaceable data can be gleaned at playback from an automated process, such as a database query. Graphics component 210 may allow users to preview edits, by, for example, allowing the users to view the graphic images as static bitmaps over the moving video. Graphics component 210 may also facilitate “re-editing.” That is, it may allow users to go back and change text associated with templates, or even the modify the templates themselves, after those templates have been dropped into a timeline. Graphics component 210 may change replaceable data without changing its position within a timeline. In addition, graphics component 210 may allow users to “re-load” previously saved edit information with all graphics information appearing in the location within a timeline specified when the edit information was saved.

In one configuration, as depicted in FIG. 2, graphics component 210 may include a graphics browser 212 and a graphics editor 214. Graphics browser 212 may include hardware, software, and/or firmware for allowing users to access and edit graphics information (e.g., templates) accessible to graphics integration module 160 while performing editing via editing system 140. Graphics browser 212 may interact with editing system 130, and it may provide one or more user interfaces (e.g., GUIs) for user interaction. In one embodiment, the interfaces may be embedded within user interfaces generated and/or presented by editing system 130. For example, editing system 130 may present timelines or storyboards associated with stored audio and video material being edited by editing system 130, and graphics browser 212 may be launched from within those timelines. Graphics browser 212 could, for instance, present an interface in response to a user double-licking on the title track of a timeline in a position at which the user wants a graphic to appear. The interface would allow the user to select a desired graphic to insert in the timeline. In addition, graphics browser 212 could be launched from an “options” or “tools” section in an interface generated by editing system 130. Graphics browser 212 may generate interfaces that include various menus, selection elements, icons, etc. Graphics browser 212 may provide various configuration, preference, style and setting options to users. For example, users can configure interfaces to show or not to show certain elements. Users may also be able to customize interfaces and save their specific settings.

When launched, graphics browser 212 may present to users a list of available folders and template files. Graphics browser 212 may also generate and display a replaceable fields editing area in response to a user selection of a displayed template. The replaceable fields editor may include a small image (“thumbnail”) of the particular template and a form for filling in replaceable fields associated with the graphic.

FIG. 3 illustrates an exemplary screen shot of an interface 310 that could be presented by graphics browser 212. As illustrated in FIG. 3, interface 310 includes an available templates and folders area 312, a replaceable fields editor area 314, and a preview area 316. Templates and folders area 312 lists all folders and template files available to integration module 160. Replaceable fields editor area 314 may include a plurality of cells corresponding to each replaceable field in the selected template. It may also include icons that indicate whether the field is a text field, still graphic field, or clip field. When a folder or file is selected, graphics browser 212 may display the template's appearance in its current form in the preview area 316. After receiving specified text, stills, or clips in the editor area 314, graphics browser 212 may refresh preview area 316 (in response to a command) in order to update the display in accordance with the changes.

Graphics editor 214, illustrated in FIG. 2, may include hardware, software and/or firmware for allowing users, while performing editing via editing system 130, to edit graphic template files that are already inserted in a timeline. Similar to graphics browser 212, graphics editor 214 may interact with editing system 130, and it may provide one or more user interfaces, which may be customizable, for user interaction. As described above, editing system 130 may present timelines associated with audio and video material for editing. Graphics editor 214 may be initiated in response to a user selecting a graphic from the presented timeline. Like graphics browser 212, graphics editor 214 may present to users a list of available folders and templates files when it is launched. Graphics editor 214 may also generate and display a replaceable fields editor, including a thumbnail of the particular template and the content of the corresponding replaceable fields. Graphics editor 214 may allow users to replace the contents of the selected graphic template on a displayed timeline without affecting anything else on the timeline.

FIG. 4A illustrates an exemplary screen shot of an interface 410 that could be presented by editing system 130. As illustrated, interface 410 may include a timeline 412 and one or more graphic templates 414. As illustrated in FIG. 4B, graphics editor 214 may present an interface 420, which includes an available templates and folders area 422, a replaceable fields editor area 424, and a preview area 426, may be displayed when a template is selected from timeline 412. Interface 420 may be presented in response to a user selecting graphic template 414.

In at least one embodiment, graphics integration module 160 may (via graphics component 210) facilitate “captioning.” For example, integration module 160 may allow users to create sub-titles for foreign-language video clips or movies. In such embodiments, graphics component 210 may include functionality to automatically add captioning to audiovisual material. In one example, text files could be created via editing system 130 in such a way that each line in the text file is associated with a particular segment of the audiovisual material. Each of these text files could be loaded into graphics browser 212 such that graphics browser 212 produces graphics templates (which may be presented on/with timelines displayed by editing system 130) with the replaceable fields of the templates filled in with text from the appropriate text file(s), and the location and duration of the templates matching its association with the audiovisual material. In certain embodiments, graphics editor 214 may allow users to edit captions that are automatically added to audiovisual material. For example, a user could select a particular caption on a timeline displayed by editing system 130 and edit the caption by modifying replaceable fields using graphics editor 214.

Playback component 220 of integration module 160, which is illustrated in FIG. 2, may interact with playback system 140 and allow users to playback graphics information with audio and video material for broadcast. Playback component 220 may facilitate such playback in a frame-accurate manner. That is, playback component 220 may play out graphics information for broadcast (e.g., television broadcast) such that the graphics information specified in saved edit information related to A/V material appears at the correct time relative to when the A/V is played out, as specified in the saved edit information. This frame-accurate playback of the graphics information includes filling all replaceable data layers of each template.

In one embodiment, playback component 220 may facilitate frame-accurate playback, with audio and video material, of graphics information generated by graphics generator 150. Playback component 220 may control graphics generator 150 in order to facilitate such frame-accurate playback. As explained above, graphics generator 150 may, in at least one embodiment, be fully or partly integrated into playback system 140. Playback component 220 may therefore be configured to control a graphics generator internal or external to playback system 140. Whether graphics generator 150 is internal or external to playback system 140, playback component 220 may interact with playback system 140 to control graphics generator 150.

In alternative embodiments, playback component 220 may facilitate frame-accurate playback of graphics information generated by sources other than graphics generator 150. For example, as explained above, one or more computer applications may be capable of producing graphics template files in the same format that graphics generator 150 creates the templates. (Other components could also be integrated into environment 100 that create graphics information.) Such applications could be distributed to users and run on one or more user devices, such as a desktop computer, coupled to network 195. This would allow users of the system to create and modify graphics template files from any appropriate computer, and then copy them onto storage 120 so that they can be accessed by editing system 130, playback system 140, and graphics generator 150.

In one embodiment, playback system 140 may perform “dynamic loading” of playlists. That is, playback system 140 may be capable of loading a particular playlist while it is currently playing out another playlist. Playback component 220 may therefore be configured with functionality to load graphics information while it is currently playing out other graphics. In one configuration, playback component 220 may implement an algorithm that loads graphics templates into graphics generator 150 dynamically. Accordingly, while graphics generator 150 is playing out graphics, playback component 220 may be continuously determining whether there is another graphic to load, and then loading it when appropriate during the playout of the playlist.

In one embodiment, one or more of the systems and modules of environment 100 depicted in FIGS. 1 and 2 may be implemented as one or more software applications running on one or more data processing systems. Such data processing systems may include general-purpose computers, servers, personal computers (e.g., a desktop), or workstations. Data processing systems may also include mobile computing devices (e.g., laptops, PDAs, a Blackberry™, an Ergo Audrey™, etc.), mobile. communications devices (e.g., cell phones), or other structures that enable users to remotely access information.

FIG. 5 illustrates an exemplary data processing system 510 consistent with the present invention. As illustrated, data processing system 510 may comprise a network interface 512, a processor 514, 1/O devices 516, a display 518, and a storage 520. A system bus (not illustrated) may interconnect such components. The illustrated components are exemplary only, and data processing system 510 may comprise additional and/or fewer components.

Network interface 512 may be any appropriate mechanism and/or module for facilitating communication with a network, such as network 195. Network interface 512 may include one or more network cards and/or data and communication ports.

Processor 514 may be configured for routing information among components and devices and for executing instructions from one or more memories. Although FIG. 5 illustrates a single processor, data processing system 510 may include a plurality of general-purpose processors and/or special purpose processors (e.g., ASICS). Processor 514 may be implemented, for example, using a Pentium™ processor commercially available from Intel Corporation.

I/O devices 516 may include components such as keyboard, a mouse, a pointing device, and/or a touch screen. I/O devices 516 may also include audio- or video-capture devices. In addition, I/O devices 516 may include one or more data reading devices and/or input ports.

Data processing system 510 may present information and interfaces (e.g., GUIs) via display 518. Display 518 may be configured to display text, images, or any other type of information. In certain configurations, display 518 may present information by way of a cathode ray tube, liquid crystal, light-emitting diode, gas plasma, or other type of display mechanism. Display 518 may additionally or alternatively be configured to audibly present information. Display 518 may be used in conjunction with I/O devices 516 for facilitating user interaction with data processing system 510.

Storage 520 may provide mass storage and/or cache memory for data processing system 510. Storage 520 may be implemented using a variety of suitable components or subsystems. Storage 520 may include a random access memory, a read-only memory, magnetic and optical storage elements, organic storage elements, audio disks, and video disks. In certain configurations, storage 520 may include or leverage one or more programmable, erasable and/or re-useable storage components, such as EPROM (erasable programmable read-only memory) and EEPROM (electrically erasable programmable read-only memory). Storage 520 may also include or leverage constantly-powered nonvolatile memory operable to be erased and programmed in blocks, such as flash memory (i.e., flash RAM). Although a single storage module is shown, any number of modules may be included in data processing system 510, and each may be configured for performing distinct functions.

Storage 520 may include program code for various applications, an operating system, an application-programming interface, application routines, and/or other executable instructions. Storage 520 may also include program code and information for communications (e.g., TCP/IP communications), kernel and device drivers, and configuration information. In one example, one or more elements of environment 100 may be implemented as software in storage 520.

For purposes of explanation only, aspects of environment 100 are described with reference to the discrete functional modules, sub-modules, and elements illustrated in FIGS. 1-5. The functionality of the illustrated elements, modules, and sub-modules, however, may overlap and/or may exist in a fewer or greater number of elements, modules, and/or sub-modules. Moreover, all or part of the functionality of the illustrated components may co-exist or be distributed among several geographically-dispersed locations.

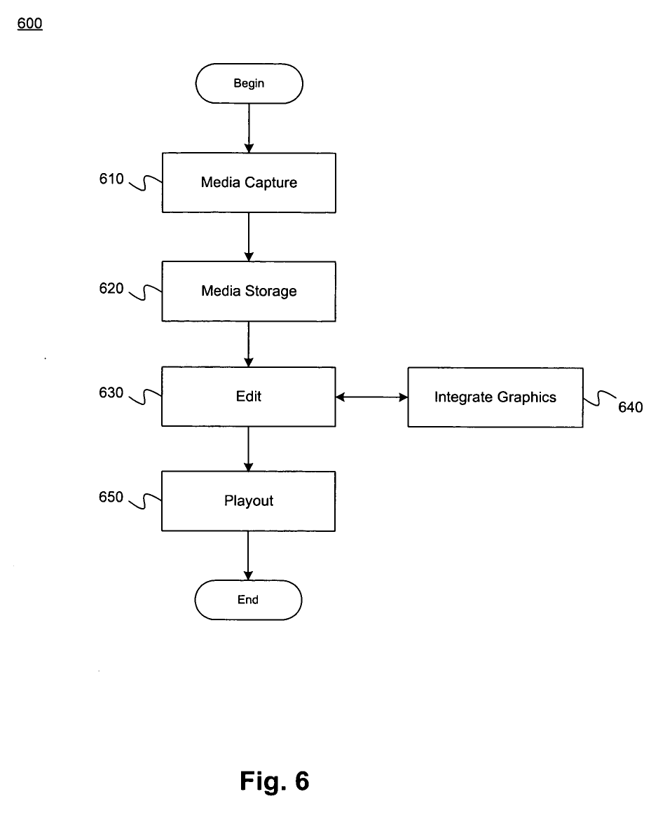

FIG. 6 is a flowchart depicting an exemplary workflow consistent with the present invention. Workflow 600 may begin with media capture (610). Media capture may include receiving, via capture devices 110, audio and video information from one or more sources (e.g., satellite feeds, tapes, etc.). After A/V material is captured, it can be stored (620). Storing the material may involve transferring captured material to a central storage resource (e.g., storage 120). Once stored, the material may be edited by one or more users (630). Editing may include viewing, manipulating and/or altering the stored material using editing system 130. Simultaneously with the editing of stored audio and video material, graphics information (generated by, e.g., graphics generator 150) may be integrated with the material and edited (640). Integration module 160 may allow users to perform this simultaneous editing and integration using editing system 130. After editing and integrating graphics to stored audio and video material, the material may be played out for broadcast (650), which may be performed via playback system 140 and integration module 160. The playback is performed such that the that the edited graphics information appears at the correct time relative to when the A/V is played out, as specified in the saved edit information.

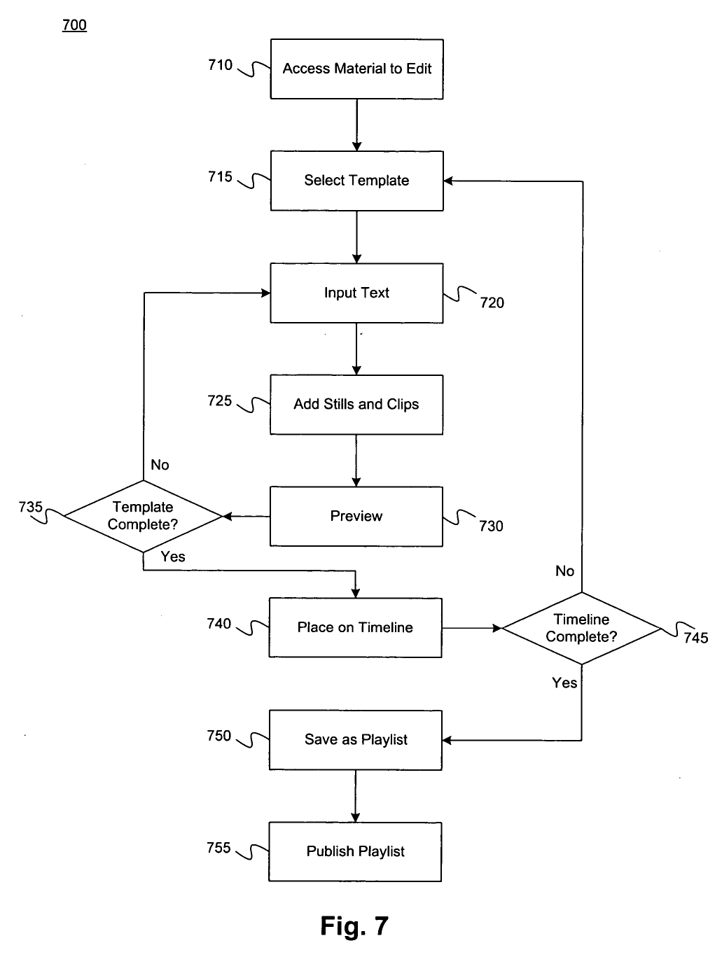

FIG. 7 is a flowchart depicting an exemplary method 700 for adding graphics consistent with the present invention. Method 700 may begin when a user accesses (e.g., via editing system 130) audio and/or video material stored in storage 120 for editing (stage 710). For example, a user may access audio and video material associated with a news story in order to edit that story. The user may access the material by interacting with a GUI provided by editing system 130. Once the user accesses the material, the user may select a template file (stage 715) to add to the audio and video material being edited. The user may select the template by selecting a file name or icon presented in a user interface generated by graphics browser 212 of integration module 160 (e.g., 312). Once the user selects a template, the user may input text into replaceable fields associated with the template (stage 720). The user may input text for each of a plurality of fields displayed in an editing interface (e.g., 314) displayed by graphics browser 212.

The user may also add stills and clips to the replaceable fields associated with the selected template (stage 725). The stills and clips may be selected directly from an interface displayed by editing system 130 and integration module 160. Alternatively, the stills and clips may be accessed and imported to editing system 130 from a third party storage system. For example, a workstation running editing system 130 may present to the user a GUI associated with the third party storage system, and the user may input commands or selection through the GUI to import the stills and clips to editing system 130 for addition to the timeline.

Once the replaceable fields associated with the selected template have been filled, the template may be previewed (stage 730). A user may preview the template via a display presented by graphics browser 212 (e.g., preview area 316). The preview may include changes made via graphics editor 214 (see discussion of FIG. 8 below). The user may continue to fill the replaceable fields of the selected template until the user is satisfied with the template and the template is complete (stage 735, Yes). After the template is completed, the user may place the template on a timeline associated with the audio and/or video material (e.g., a news story) (stage 740). Users can place templates on a timeline by inputting commands to graphics browser 212. Users may continue to add graphics to the timeline until the timeline is complete (stage 745; Yes). Once the timeline is complete, it may be saved as a playlist (stage 750) and stored in a working directory. The playlist may then be published (stage 755) to enable other components of environment 100 to access the playlist via network 195. For example, playback system 140 may access published playlists and output those playlists for a television broadcast. Publishing of the playlist (stage 755) is optional.

Although method 700 of FIG. 7 refers to filling replaceable fields associated with a selected template (e.g., stages 720, 725), those actions are optional and may not be included in method 700. For example, a user could select the graphics information (stage 715) and add the selected template to the audio and video material (stage 740), without having to insert content into a replaceable field. In fact, the selected template may not include any replaceable fields. In addition, the previewing (stage 730) and determining (stage 735) illustrated in FIG. 7 are optional and may not be included in method 700. That is, the user could simply select a template (stage 715) and then place the template on a timeline (stage 740), without inserting content into replaceable fields or previewing the template.

FIG. 8 is a flowchart depicting an exemplary editing method 800 consistent with the present invention. Method 800 may begin when a user accesses (via editing system 130) a timeline to edit (stage 810). The user may access the timeline by accessing a timeline displayed in a GUI provided by editing system 130 (e.g., 410). Once the user accesses the timeline, the user may select a template file from the timeline to edit (stage 815). The user may select the template by selecting a file name or icon. Once the user selects a template from the timeline, the user may preview the template (stage 820). In one embodiment, selecting the template from the timeline may initiate graphics editor 214, and graphics editor 214 may present a preview of the template.

At this point, the user may edit text associated with replaceable fields of the selected template (stage 825). Editing text may include inputting, by the user, text for each of a plurality of fields displayed in an editing interface (e.g., 424) displayed by graphics editor 214. Editing text may also include selecting another graphics file displayed by graphics editor 214 to import the text from that other graphic to the selected template. The user may also add stills and clips to the replaceable fields of the selected template (stage 830). Adding stills and clips may be performed via graphics editor 214. Aspects of stage 830 may parallel aspects of stage 725 of FIG. 7.

Once edits have been performed, the template may be previewed (stage 835). A user may preview an edited template via a display presented by graphics editor 214. The user may continue to edit and preview the selected template until the user is satisfied with the edits and all edits to the template are complete (stage 840, Yes). After the edits for the selected template are complete, the user may select another template from the timeline for editing and continue the process until all graphics in the timeline needing editing have been edited (stage 845; Yes). After the timeline has been edited, it may be saved as a playlist (stage 850) and stored in a working directory. The timeline may be saved with a different name if the original version is to be preserved. The playlist may then be published (stage 855) to enable other components of environment 100 to access the playlist via network 195. Publishing of the playlist (stage 855) is optional.

FIGS. 6-8 are consistent with exemplary implementations of the present invention. The sequences of events described in FIGS. 6-8 are exemplary and not intended to be limiting. Other steps may therefore be used, and even with the steps depicted in FIGS. 6-8, the particular order of events may vary without departing from the scope of the present invention. Further, the illustrated steps and functionality may overlap and/or may exist in fewer steps. Moreover, certain steps may not be present and additional steps may be implemented in the illustrated method and workflow. In addition, the illustrated steps may be modified without departing from the scope of the present invention.

The foregoing description of possible implementations consistent with the present invention does not represent a comprehensive list of all such implementations or all variations of the implementations described. The description of only some implementations should not be construed as an intent to exclude other implementations. Artisans will understand how to implement the invention in the appended claims in many other ways, using equivalents and alternatives that do not depart from the scope of the following claims.

What is claimed is:

1. A system for editing audiovisual material, comprising:
a capture system that captures audiovisual material from at least one source;
an editing system that enables editing of the audiovisual material;
a playback system for outputting edited audiovisual material for broadcast; and
a graphics integration module embedded within the editing system and the playback system that associates graphics information with edited audiovisual material while the audiovisual material is being edited such that the graphics information appears with the edited audiovisual material at a correct time relative to when the edited audiovisual material is output by the playback system.

2. The system of claim 1, wherein the integration module includes a browser that is launched when the editing system receives a command to associate the graphics information with the audiovisual material.

3. The system of claim 1, wherein the editing system displays a timeline associated with the audiovisual information and including the graphics information, and wherein the integration module includes an editor that is initiated when the editing system receives a command to edit the graphics information included in the timeline.

4. The system of claim 1, wherein the integration module allows insertion of the graphics information into the audiovisual material.

5. The system of claim 4, wherein the integration module allows editing of the graphics information during the insertion of the graphics information.

6. The system of claim 5, wherein the integration module allows re-editing of the graphics information after insertion of the graphics information.

7. The system of claim 1, wherein the integration module allows simultaneous editing of the audiovisual material and the graphics information.

8. The system of claim 1, wherein the storage element comprises at least one database.

9. The system of claim 1, wherein the storage element comprises a shared storage network.

10. The system of claim 1, wherein the playback system comprises a system for outputting the edited audiovisual information for a television broadcast.

11. The system of claim 1, wherein the at least one source comprises at least one of a satellite feed, a tape, and a computer application.

12. The system of claim 1, wherein the graphics information comprises at least one of an image, text, and a clip.

13. The system of claim 1, further comprising a graphics generator coupled to the storage for playing out the graphics information for broadcast.

14. The system of claim 13, wherein the graphics generator generates the graphics information.

15. The system of claim 13, wherein the graphics generator plays out the graphics information for broadcast by accessing the graphics information from the storage.

16. The system of claim 13, wherein the graphics generator is located within the playback system.

17. The system of claim 13, wherein the graphics integration module obtains information from the playback system to control the graphics generator so that it plays out the graphics information at the correct time relative to when the edited audiovisual material is output by the playback system.

18. The system of claim 13, wherein the graphics generator comprises at least one application running on a data processing system.

19. The system of claim 1, wherein the graphics information comprises at least one template having at least one replaceable field.

20. The system of claim 1, wherein the integration module comprises a module for inserting content into the at least one replaceable field in response to a user editing the audiovisual information.

21. The system of claim 1, wherein the editing system comprises at least one application running on at least one data processing system.

22. The system of claim 1, wherein the playback system comprises at least one application running on at least one data processing system.

23. The system of claim 1, wherein the capture system comprises at least one encoder.

24. A method for processing audiovisual material and graphics information, the method comprising:
capturing audiovisual material from at least one source;
generating graphics information;
editing the graphics information while editing the audiovisual material; and
outputting the edited audiovisual material and edited graphics information for broadcast such that the edited graphics information appears at a correct time relative to when the audiovisual material is output.

25. The method of claim 24, further comprising:
associating the graphics information with the audiovisual material.

26. The method of claim 25, wherein associating the graphics information comprises:
selecting the graphics information from a list; and
inserting the selected graphics information into a timeline associated with the audiovisual material.

27. The method of claim 24, wherein editing the graphics information simultaneously with editing the audiovisual material comprises:
selecting the graphics information from a timeline associated with the audiovisual information.

28. The method of claim 27, wherein editing the graphics information simultaneously with editing the audiovisual material further comprises:
inserting content into at least one replaceable field associated with the selected graphics information.

29. The method of claim 24, wherein outputting includes:
outputting the edited audiovisual material and edited graphics information for a television broadcast.

30. The method of claim 24, wherein capturing audiovisual material includes:
capturing audiovisual material from at least one of a satellite feed, a tape, and a computer application.

31. A graphics integration module, comprising:
a first application embedded within an editing system, wherein the editing system allows editing of audiovisual content, the first application including:
a browser that allows graphics information to be selected and added to the audiovisual content while the audiovisual content is edited; and
an editor that allows graphics information added to the audiovisual content to be edited; and
a second application embedded within a playback system, wherein the playback system outputs edited audiovisual content and edited graphics information for broadcast, the second application controlling the playback system to output edited graphics information such that the edited graphics information appears with the edited audiovisual content at a correct time relative to when the audiovisual content is output by the playback system in accordance with the edited audiovisual content.

32. The graphics integration module of claim 31, wherein a graphics generator is coupled to the playback system, and wherein the second application controls the graphics generator so that it plays out the graphics information at the correct time relative to when the edited audiovisual material is output by the playback system.

33. The graphics integration module of claim 32, wherein the graphics generator is located internal to the playback system.

34. The graphics integration module of claim 32, wherein the graphics generator is located external to the playback system.

35. The graphics integration module of claim 31, wherein the first application includes functionality for automatically adding caption information received from the editing system to the audiovisual content.

36. The graphics integration module of claim 35, wherein the editing system creates text files in which each line of the text files is associated with a particular segment of the audiovisual content.

37. The graphics integration module of claim 36, wherein the first application loads the text files and produces graphics templates that include text from the text files for display via the browser.

38. A data processing system, comprising:
capture means for capturing audiovisual material from at least one source;
graphics means for generating graphics information;
editing means for allowing simultaneous editing of the audiovisual material and the graphics information;
playback means for outputting edited audiovisual material and edited graphics information for broadcast; and
means for controlling the playback means to output edited graphics information such that the edited graphics information appears at a correct time relative to when the audiovisual material is output.

39. A computer-readable medium containing instructions for controlling a computer system to perform a method, the computer system having a processor for executing the instructions, the method comprising:
capturing audiovisual material from at least one source;
generating graphics information;
editing the graphics information simultaneously with editing the audiovisual material; and
outputting the edited audiovisual material and edited graphics information for broadcast such that the edited graphics information appears at a correct time relative to when the audiovisual material is output.
